(19) United States
(12) Patent Application Publication
(10) Pub. No.: US 2026/0281160 A1
(43) Pub. Date: Sep. 17, 2026

(54) INFORMATION PROCESSING DEVICE, INFORMATION PROCESSING METHOD, AND NON-TRANSITORY COMPUTER-READABLE RECORDING MEDIUM

(71) Applicant: NEC Corporation, Tokyo (JP)

(72) Inventor: Rei ITO, TOkyo (JP)

(73) Assignee: NEC Corporation, Tokyo (JP)

(21) Appl. No.: 19/554,842

(22) Filed: Mar. 3, 2026

(30) Foreign Application Priority Data
Mar. 14, 2025 (JP) 2025-040864

(51) Int. Cl. H04L 9/40; G06N 20/00; G06Q 10/10

(52) U.S. Cl. CPC H04L 63/20; G06N 20/00; G06Q 10/103

(57) ABSTRACT

An information processing device according to one aspect of the present disclosure includes an acquisition unit that acquire characteristic information indicating a characteristic regarding security of a project in a target project, and a target check list that is a check list regarding an implementation item of a security countermeasure input for the target project, an estimation unit that estimate the implementation item to be implemented for the target project using a learning model that has learned a relationship between the characteristic information and the check list input for each project and a confirmation result regarding an implementation status of the implementation item and the acquired characteristic information and the acquired target check list, and an output unit that output the estimated implementation item to be implemented.

This application is based upon and claims the benefit of priority from Japanese Patent Application No. 2025-040864, filed on Mar. 14, 2025, the disclosure of which is incorporated herein in its entirety by reference.

### TECHNICAL FIELD

The present disclosure relates to an information processing device, an information processing method, and a program.

### BACKGROUND ART

In the progress of a project, it is required to appropriately determine what should be implemented. On the other hand, JP 2013-61694 A discloses a technique for presenting priority orders of anti-risk measures in the case of performing project risk management. Specifically, J P 2013-61694 A discloses that the degree of influence of a risk, the occurrence probability, and the weight of anti-risk measures are updated together with the progress of a project, and priority order of the anti-risk measures is created.

### SUMMARY

An information processing device according to one aspect of the present disclosure includes an acquisition unit that acquire characteristic information indicating a characteristic regarding security of a project in a target project, and a target check list that is a check list regarding an implementation item of a security countermeasure input for the target project, an estimation unit that estimate the implementation item to be implemented for the target project using a learning model that has learned a relationship between the characteristic information and the check list input for each project and a confirmation result regarding an implementation status of the implementation item and the acquired characteristic information and the acquired target check list, and an output unit that output the estimated implementation item to be implemented.

An information processing method according to an aspect of the present disclosure includes acquiring characteristic information indicating a characteristic regarding security of a project in a target project, and a target check list that is a check list regarding an implementation item of a security countermeasure input for the target project, estimating the implementation item to be implemented for the target project using a learning model that has learned a relationship between the characteristic information and the check list input for each project and a confirmation result regarding an implementation status of the implementation item and the acquired characteristic information and the acquired target check list, and outputting the estimated implementation item to be implemented.

A program according to an aspect of the present disclosure causes a computer to execute processing of acquiring characteristic information indicating a characteristic regarding security of a project in the target project, and a target check list that is a check list regarding an implementation item of a security countermeasure input for the target project, processing of estimating the implementation item to be implemented for the target project using a learning model that learns a relationship between the characteristic information for each project, the check list that has been input, and a confirmation result regarding an implementation status of the implementation item, and the acquired characteristic information and the target check list, and processing of outputting the estimated implementation item to be implemented.

### BRIEF DESCRIPTION OF THE DRAWINGS

FIG. 1 is a block diagram illustrating an example of a functional configuration of an information processing device according to the present disclosure;

FIG. 2 is a first flowchart for explaining an example of an operation of an information processing device according to the present disclosure;

FIG. 3 is a diagram schematically illustrating an example of a configuration including an information processing device according to the present disclosure;

FIG. 4 is a first block diagram illustrating an example of a functional configuration of the information processing device according to the present disclosure;

FIG. 5 is a diagram illustrating an example of project information according to the present disclosure;

FIG. 6 is a diagram illustrating an example of an input check list according to the present disclosure;

FIG. 7 is a diagram illustrating an example of confirmation result information according to the present disclosure;

FIG. 8 is a diagram illustrating an example of output information according to the present disclosure;

FIG. 9 is a second flowchart for explaining an example of an operation of the information processing device according to the present disclosure;

FIG. 10 is a third flowchart for explaining an example of an operation of the information processing device according to the present disclosure;

FIG. 11 is a second block diagram illustrating an example of a functional configuration of the information processing device according to the present disclosure;

FIG. 12 is a diagram illustrating an example of incident information according to the present disclosure; and

FIG. 13 is a block diagram illustrating an example of a hardware configuration of a computer device that implements the information processing device according to the present disclosure.

### EXAMPLE EMBODIMENT

Hereinafter, example embodiments of the present disclosure will be described with reference to the drawings.

### First Example Embodiment

An outline of an information processing device according to a first example embodiment will be described.

An example of an information processing device of the present disclosure presents implementation items of security countermeasures to be implemented based on a check list input for a target project. Here, the project in the present disclosure is a project capable of implementing a countermeasure regarding cyber security. For example, the project is system development and operation, but is not limited to these examples. The check list is data related to implementation items of security countermeasures. More specifically, the check list may be data in which actions to be implemented in the project are indicated as check items. For example, a person such as a person in charge of a project inputs an implementation status of implementation items of security countermeasures implemented for the project to the check list. The information processing device uses, for example, the check list input in this manner.

The information processing device in the present disclosure is implemented in, for example, a server device. The information processing device may be implemented in a cloud server. The information processing device is communicably connected to various devices via a wired or wireless network. For example, the information processing device is communicably connected to the terminal device. The terminal device is a device having an input/output function operated by a user. The terminal device may be a personal computer, a smartphone, a tablet terminal, or the like. The information processing device may output information to the terminal device. The information processing device is not limited to this example. For example, the information processing device may be implemented in a terminal device. In the present disclosure, an example in which the information processing device is implemented in a server device and is communicably connected to a terminal device will be mainly described.

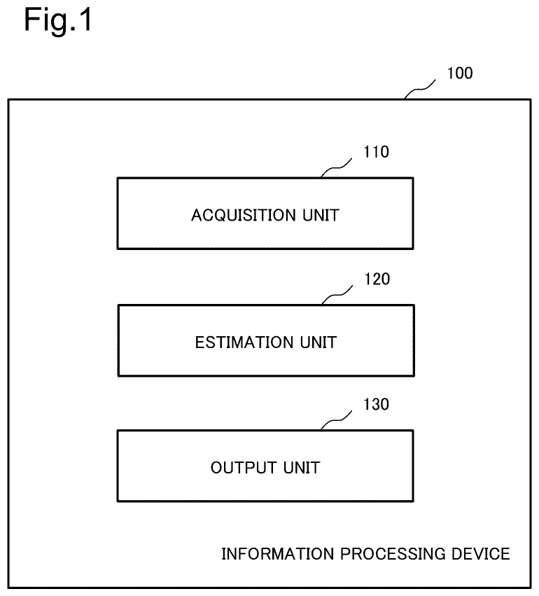

FIG. 1 is a first block diagram illustrating an example of a functional configuration of an information processing device 100. As illustrated in FIG. 1, the information processing device 100 includes an acquisition unit 110, an estimation unit 120, and an output unit 130.

The acquisition unit 110 acquires a check list in a target project. More specifically, the implementation status of the security countermeasure is input into the check list by a person such as a person in charge of the target project. The acquisition unit 110 acquires the check list to which the implementation status is input. Here, the check list in which the implementation status is input in the target project is also referred to as a target check list. For example, the acquisition unit 110 acquires the target check list from the terminal device. The present disclosure is not limited to this example, and the acquisition unit 110 may acquire the target check list from another device that can communicate with the information processing device 100.

The acquisition unit 110 acquires characteristic information of the target project. The characteristic information indicates a characteristic regarding security of the project. An example of the characteristic information is information regarding confidentiality, availability, and integrity in a project. For example, the characteristic information may be information indicating a level of confidentiality, availability, and integrity required for the project. For example, the acquisition unit 110 acquires the characteristic information of the target project from the terminal device. The present disclosure is not limited to this example, and the acquisition unit 110 may acquire the characteristic information from another device that can communicate with the information processing device 100.

In this manner, the acquisition unit 110 acquires the characteristic information indicating the characteristic regarding the security of the project in the target project and the target check list that is the check list regarding the implementation item of the security countermeasure input for the target project. The acquisition unit 110 is an example of an acquisition means.

The estimation unit 120 estimates an implementation item to be implemented for a target project. At this time, the estimation unit 120 performs estimation processing using a learning model. The learning model is a learned model that has learned the characteristic information and the relationship between the implementation status regarding the implementation item and the confirmation result regarding the implementation status. The confirmation result is information indicating whether the security countermeasure is appropriately implemented for the project, which is determined by a person such as a project manager. At this time, the person such as a project manager determines whether the security countermeasure is appropriately implemented based on the input check list. That is, the confirmation result can also be said to be information indicating the appropriateness of the security countermeasure determined for the project based on the input check list.

The learning model may be, for example, a model in which a relationship between the characteristic information and the input check list in the past project and the confirmation result based on the input check list in the past project is learned. In this case, the learning model may be generated by machine learning based on teacher data using a ground truth label as a confirmation result with respect to the characteristic information and the input check list. Alternatively, the learning model may be a model that learns the relationship between the characteristic information and the input check list and the confirmation result, and outputs the implementation item necessary for determining that the security countermeasure has been appropriately implemented for the project having a predetermined characteristic. The learning model is not limited to these examples.

For example, the estimation unit 120 obtains an output from the learning model by inputting the characteristic information in the target project and the target check list to the learning model. At this time, in a case where the learning model is a model that outputs an implementation item necessary for determining that the security countermeasure has been appropriately implemented, the estimation unit 120 may estimate the implementation item to be implemented for the target project by obtaining the output implementation item. It is assumed that the learning model is a model generated by machine learning based on teacher data having a ground truth label as a confirmation result with respect to the characteristic information and the input check list. In this case, the estimation unit 120 inputs the characteristic information in the target project and the target check list to the learning model. Then, the estimation unit 120 may estimate the implementation item to be implemented for the target project from a parameter such as a weight for a term relevant to each implementation item of the learning model and the implementation status based on the target check list. For example, in a case where an implementation item having a weight larger than a predetermined threshold is not implemented in a target project, the estimation unit 120 may estimate the non-implemented implementation item as an implementation item to be implemented in the target project. Alternatively, the estimation unit 120 may estimate an implementation item having a weight larger than a predetermined threshold as an implementation item to be implemented for the target project. The estimation method is not limited to this example.

In this manner, the estimation unit 120 estimates the implementation item to be implemented for the target project using the learning model that has learned the relationship between the characteristic information and the input check list for each project and the confirmation result regarding the implementation status of the implementation item and the acquired characteristic information and target check list. The estimation unit 120 is an example of an estimation means.

The output unit 130 outputs the information estimated by the estimation unit 120. Specifically, the output unit 130 may output, to the terminal device, information indicating the estimated implementation item to be implemented for the target project. For example, the output unit 130 may output information indicating the implementation item to the terminal device, so that the information is displayed on a display included in the terminal device.

In this manner, the output unit 130 outputs the estimated implementation item to be implemented. The output unit 130 is an example of an output means.

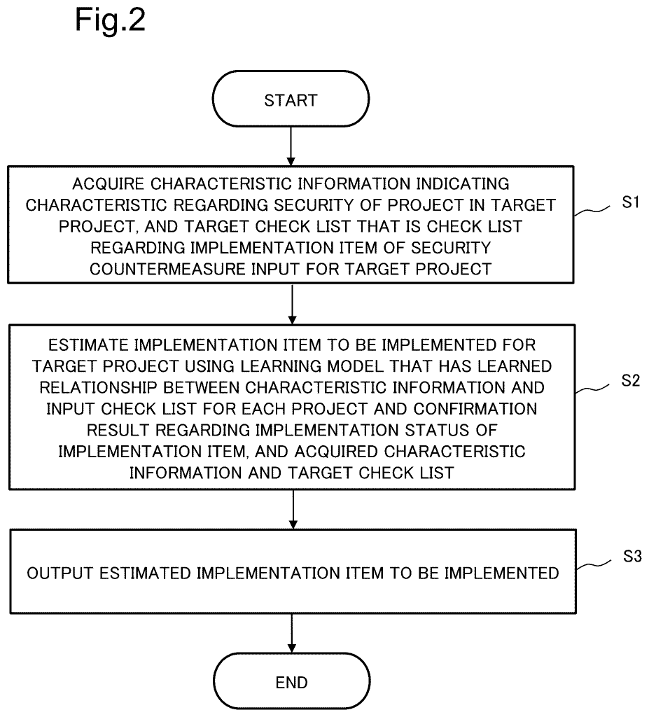

Next, an exemplary operation of the information processing device 100 will be described with reference to FIG. 2. In the present disclosure, each step of the flowchart is represented using a number given to each step, such as “S1”.

FIG. 2 is a first flowchart for explaining an example of the operation of the information processing device 100.

The acquisition unit 110 acquires the characteristic information indicating the characteristic regarding the security of the project in the target project and the target check list that is the check list regarding the implementation item of the security countermeasure input for the target project (S1).

The estimation unit 120 estimates the implementation item to be implemented for the target project using the learning model that has learned the relationship between the characteristic information and the input check list for each project and the confirmation result regarding the implementation status of the implementation item and the acquired characteristic information and target check list (S2).

The output unit 130 outputs the estimated implementation item to be implemented.

In this manner, the information processing device 100 according to the first example embodiment acquires the characteristic information indicating the characteristic regarding the security of the project in the target project and the target check list that is the check list regarding the implementation item of the security countermeasure input for the target project. The information processing device 100 estimates the implementation item to be implemented for the target project using the learning model that has learned the relationship between the characteristic information and the input check list for each project and the confirmation result regarding the implementation status of the implementation item and the acquired characteristic information and target check list. Then, the information processing device 100 outputs the estimated implementation item to be implemented.

As a result, the information processing device 100 can present the implementation item to be implemented for the target project. Therefore, the user such as a person in charge of the project and a project manager can easily confirm, for example, which security countermeasure is to be implemented and whether the security countermeasure to be implemented is appropriately implemented. That is, the information processing device 100 can support confirmation work regarding security countermeasures to be implemented in a project.

### Second Example Embodiment

Next, an information processing device according to a second example embodiment will be described. In the second example embodiment, another example related to the information processing device described in the first example embodiment will be further described. A part of the description of content overlapping with that of the first example embodiment will be omitted.

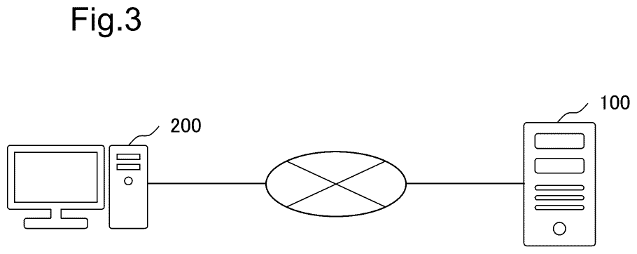

FIG. 3 is a diagram schematically illustrating an example of a configuration including an information processing device. As illustrated in FIG. 3, the information processing device 100 is communicably connected to a terminal device 200 via a wired or wireless network.

The terminal device 200 is a device used by the user. The user is, for example, a person in charge of a project, a project manager, a security manager, or the like. The configuration communicably connected to the information processing device 100 is not limited to this example. For example, the information processing device 100 may be able to communicate with other devices.

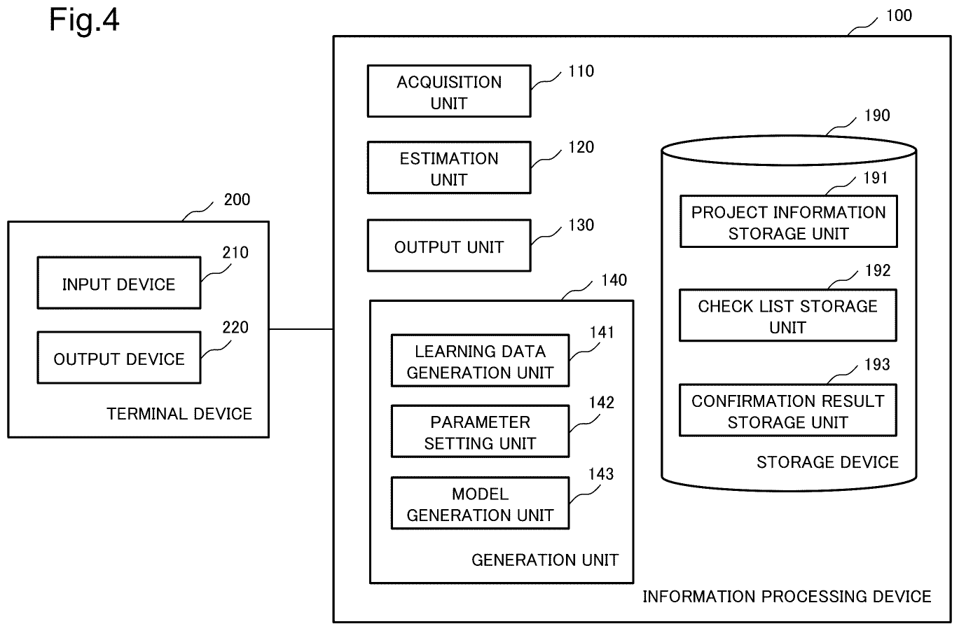

FIG. 4 is a first block diagram illustrating an example of a functional configuration of the information processing device 100. Specifically, FIG. 4 illustrates an example of functional configurations of the information processing device 100 and the terminal device 200.

The terminal device 200 includes an input device 210 such as a keyboard and a touch panel. The terminal device 200 includes an output device 220 such as a display and a speaker.

The information processing device 100 includes an acquisition unit 110, an estimation unit 120, an output unit 130, and a generation unit 140. The information processing device 100 includes a storage device 190. A plurality of storage devices 190 may be provided. The storage device 190 may be an external device capable of communicating with the information processing device 100. The storage device 190 may exist both inside and outside the information processing device 100.

The storage device 190 stores various types of information. The storage device 190 may be a device that functions as a database server. In the example of FIG. 4, the storage device 190 includes a project information storage unit 191, a check list storage unit 192, and a confirmation result storage unit 193. The project information storage unit 191, the check list storage unit 192, and the confirmation result storage unit 193 may be provided in different storage devices.

The processing of the information processing device 100 is classified into a phase of generating a learning model and a phase of outputting an estimation result for a target project using the learning model. The phase of generating the learning model is referred to as a learning phase. A phase of outputting the estimation result for the target project using the learning model is referred to as an inference phase.

### (Learning Phase)

In the learning phase, the generation unit 140 generates a learning model based on information regarding a past project. Specifically, the generation unit 140 includes a learning data generation unit 141, a parameter setting unit 142, and a model generation unit 143.

The learning data generation unit 141 generates learning data using information regarding a past project. For example, the learning data generation unit 141 acquires the project information from the project information storage unit 191.

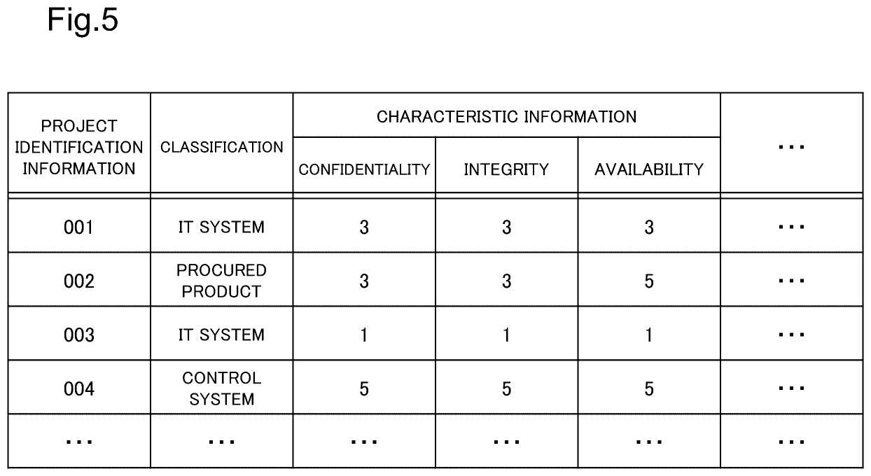

The project information storage unit 191 stores project information. The project information indicates a feature of a project executed in the past. FIG. 5 is a diagram illustrating an example of project information. In the example of FIG. 5, various types of information are associated with project identification information for identifying a project. For example, information indicating the classification of the project and characteristic information are associated with the project identification information. In this manner, the project information includes at least the characteristic information. The project information may further include different information. The learning data generation unit 141 acquires at least the characteristic information from the project information storage unit 191.

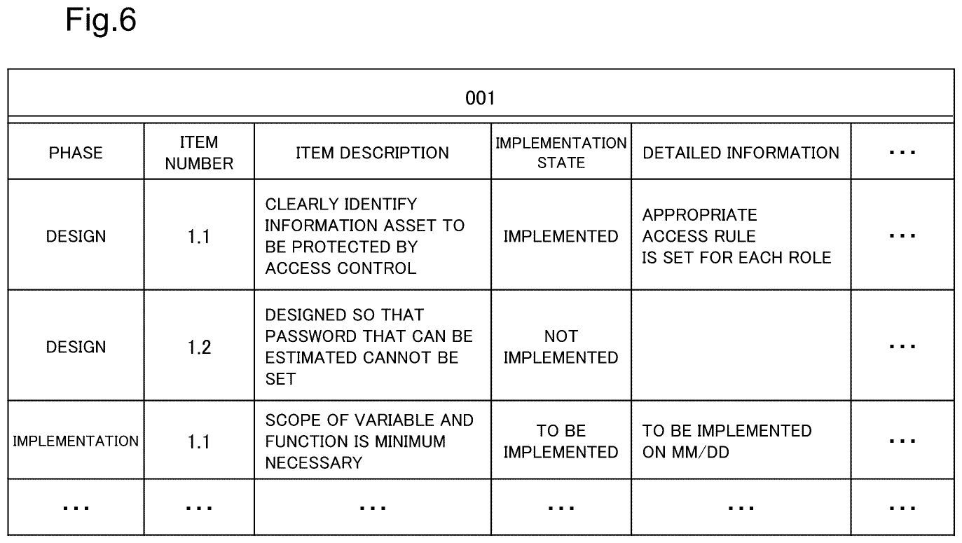

The learning data generation unit 141 acquires information regarding an input check list from the check list storage unit 192. The check list storage unit 192 stores an input check list in a project executed in the past. FIG. 6 is a diagram illustrating an example of an input check list. In the example of FIG. 6, an input check list in a project whose project identification information is “001” is illustrated. Each record in the check list is relevant to an implementation item. In this example, the check list includes information in which the phase, item number, item description, implementation state, and detailed information of the project are associated with each implementation item. The check list may include information associated with further information.

The phase, item number, and item description indicate description of implementation items. The implementation state and the detailed information are information input by a person. For example, the implementation state and the detailed information are information input when the person in charge of the project or the like confirms the implementation item using the check list. The implementation state indicates a response status to the implementation item. The implementation state indicates, for example, information indicating whether the implementation item has been implemented or has not been implemented. The present disclosure is not limited to this example, and the implementation state may indicate a further response status such as implementation schedule, implementation unnecessary, and partial implementation. The detailed information is a sentence indicating details of the implementation state. For example, the detailed information may be a comment on the implementation item input by a person in charge of the project or the like. Information including the implementation state and detailed information may be referred to as an implementation state.

In the example of FIG. 6, the first record indicates an implementation item whose phase is “design” and item number is “1.1”. The implementation item is associated with an item description of “clarifying an information asset to be protected by access control”. In this example, the implementation state of the implementation item of item number “1.1” is “implemented”. Further, the detailed information indicates a sentence “an appropriate access rule is set for each role”.

The learning data generation unit 141 acquires such a check list for each project executed in the past.

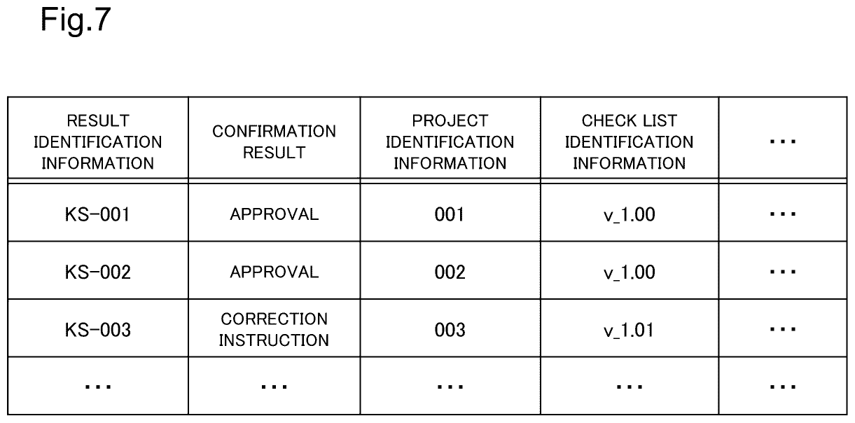

The learning data generation unit 141 acquires the confirmation result from the confirmation result storage unit 193. The confirmation result storage unit 193 stores confirmation result information. The confirmation result information is information indicating, for each project, a confirmation result determined based on an input check list in a project executed in the past. FIG. 7 illustrates an example of the confirmation result information. In the example of FIG. 7, each record is relevant to a confirmation result in one project. In this example, the confirmation result information includes information in which the result identification information, the confirmation result, the project identification information, and the check list identification information are associated. The confirmation result information may include information associated with further information.

The result identification information is information for identifying the confirmation result. For example, the first record indicates a confirmation result for the project of the project identification information “001”. In this example, the confirmation result is indicated as “approved”. That is, the project with the project identification information “001” indicates that a person such as a project manager determines that the security countermeasure is appropriately implemented. In the third record, the confirmation result is indicated as “correction instruction” for the project with the project identification information “001”. That is, the project with the project identification information “003” indicates that a person such as a project manager determines that the security countermeasure is not appropriately implemented.

The learning data generation unit 141 acquires such a confirmation result for each project executed in the past.

Then, the learning data generation unit 141 generates learning data using the acquired information regarding the past project. The learning data is a data set including information in which characteristic information, an input check list, and a confirmation result are associated for each project. The learning data generation unit 141 registers the characteristic information, the input check list, and the confirmation result relevant to the same project identification information in the learning data in association with each other. At this time, the learning data generation unit 141 registers the confirmation result as a ground truth label. That is, it can be said that the learning data is teacher data in which the confirmation result is registered as a ground truth label with respect to the characteristic information and the input check list. A specific example regarding generation of the learning data will be described later.

In this manner, the learning data generation unit 141 generates the learning data with the confirmation result as the ground truth label based on the characteristic information, the input check list, and the confirmation result in the past project.

The parameter setting unit 142 sets an initial value of a parameter when the learning model is generated. An example of the parameter is a weight. The learning model is constructed based on elements relevant to the implementation items. For example, the learning model is a function including a term indicating each element. At this time, a weight exists as a parameter relevant to each element. The weight is information indicating the degree of influence of the implementation item on the confirmation result. That is, the implementation item having a large weight can be said to be an implementation item having a large influence of the input value related to the implementation item on the information output in the learning model. That is, the weight can also be said to be information indicating the importance level of the implementation item. For example, in a case where the regression analysis is used to generate the learning model, the weight may be a coefficient (regression coefficient) of the regression model. The specific example of the weight is not limited to this example. The weight may vary depending on a learning algorithm used to generate the learning model. The parameter setting unit 142 sets an initial value of a parameter attached to each element in the learning model. A specific example of the initial value of the parameter will be described later.

In this manner, the parameter setting unit 142 sets the initial value of the weight for each implementation item.

The model generation unit 143 generates a learning model using the learning data. For example, the model generation unit 143 optimizes the weight in the function indicating the learning model by machine learning using the learning data. At this time, the machine learning method may be a method related to regression analysis such as logistic regression or a method related to classification such as a support vector machine. The machine learning method is not limited to this example.

Next, a specific example regarding generation of the learning model will be described. First, when generating learning data, the learning data generation unit 141 acquires characteristic information, an input check list, and a confirmation result in a predetermined project that is one of the projects executed in the past. Then, the learning data generation unit 141 quantifies the acquired information.

Here, the characteristic information is information indicating the level of confidentiality, integrity, and availability. For example, it is assumed that each of confidentiality, integrity, and availability is indicated at five levels from 1 to 5. The value of the level of confidentiality is t₁. The value of the level of integrity is t₂. The value of the availability level is t₃. The learning data generation unit 141 normalizes each of t₁, t₂, and t₃. The normalized values of t₁, t₂, and t₃ are denoted by T₁, T₂, and T₃.

The learning data generation unit 141 quantifies the implementation status of each implementation item based on the input check list. For example, the implementation state of the implementation item is xᵢ (1<=i<=n). Here, n represents the number of items. That is, when there are 600 implementation items in the check list, n=600. xᵢ represents a value relevant to the implementation state. For example, in a case where the implementation state is “implemented”, xᵢ=1.0 may be set. For example, in a case where the implementation state is “not implemented”, xᵢ=0.0 may be set. The present disclosure is not limited to this example, and relevant numerical values may be determined even in a case where the implementation state is “partially implemented”, “to be implemented”, or the like.

For example, the detailed information of the implementation item is yᵢ. The detailed information is information indicating a sentence. Therefore, for example, the learning data generation unit 141 may set the information obtained by converting the detailed information into the vector representation as yᵢ. Specifically, the learning data generation unit 141 converts the sentence indicated in the detailed information into vector representation by an algorithm such as Doc2Vec. Therefore, for example, yᵢ=(yᵢ₁, yᵢ₂, . . . , yᵢₘ) is expressed. Here, m is the number of dimensions of the vector. As an example, when m=4, yᵢ=(0.0, 0.01, 0.75, 0.24) is expressed.

The learning data generation unit 141 quantifies the confirmation result. The confirmation result is a ground truth label. For example, the confirmation result is z. If the confirmation result is either approval or a correction instruction, the value of z also has two possible values. For example, z may take a value of 1 or 0.

Then, the learning data generation unit 141 associates the characteristic information, the input check list, and the confirmation result in the predetermined project. For example, the learning data generation unit 141 associates T₁, T₂, T₃, (x₁, . . . , xₙ), (y₁, . . . , yₙ), and z relevant to a predetermined project. The associated information is relevant to learning data.

The learning data generation unit 141 may perform these processes as many as the number of projects executed in the past. That is, as the learning data generation unit 141 repeatedly performs these processes as many times as the number of projects, the learning data increases.

The parameter setting unit 142 sets an initial value of the weight for each implementation item. For example, the weight is wᵢ. That is, there are n weights wᵢ. At this time, the parameter setting unit 142 may set the initial value such that the sum of wᵢ from i=1 to i=n becomes 1.0. All of the initial values may be the same value, or at least some of the initial values may be different values. For example, wᵢ=1.0/n may be satisfied. For example, the initial value of the weight may be different according to the characteristic information. More specifically, an initial value of the weight relevant to each implementation item may be set according to the level of confidentiality, integrity, and availability. In this case, the parameter setting unit 142 sets the initial value using the importance level information. The importance level information is information indicating the importance level for each implementation item. The importance level information is stored in the storage device 190, for example. For example, the parameter setting unit 142 may use the importance level information to set the initial value of the weight to be larger for an implementation item having a higher importance level.

The model generation unit 143 performs learning processing using the generated learning data and the initial value of the weight. At this time, for example, a function such as the following Expression 1 is defined.

z=f(w₁x₁y₁,w₂x₂y₂, . . . ,wₙxₙyₙ,T₁,T₂,T₃) [Math. 1]
x₁y₁ is an example of an element relevant to the implementation item. w₁ is an example of a parameter attached to the element.

For example, the model generation unit 143 performs learning for the function f shown in Expression 1 using the generated learning data and the initial value of the weight as inputs. As a result, the weight is optimized.

The generation of the learning model is not limited to this example. For example, a value related to the characteristic information may be integrated into each element relevant to the implementation item. Specifically, the element for each implementation item may be defined as T₁T₂T₃xᵢyᵢ.

### (Inference Phase)

The acquisition unit 110 acquires the characteristic information of the target project and the target check list. The characteristic information of the target project and the target check list may be stored in the storage device 190. That is, the characteristic information of the target project may be stored in the project information storage unit. The target check list may be stored in the check list storage unit 192. The acquisition unit 110 may acquire the characteristic information of the target project and the target check list from the storage device 190.

Alternatively, the acquisition unit 110 may acquire the characteristic information of the target project and the target check list from the terminal device 200. In this case, the user of the terminal device 200 uses the input device 210 to input the characteristic information of the target project and the target check list. The user may input by designating the characteristic information of the target project and the file of the target check list. The terminal device 200 transmits the input characteristic information of the target project and the input target check list to the information processing device 100. The acquisition unit 110 may acquire the characteristic information of the target project and the target check list transmitted from the terminal device 200.

The estimation unit 120 performs estimation processing for a target project using the acquired characteristic information and target check list. For example, the estimation unit 120 may estimate a confirmation result for the target project. Specifically, the estimation unit 120 inputs the acquired characteristic information and the information of the acquired target check list to the learning model. At this time, a confirmation result is output by the learning model. The estimation unit 120 estimates the output confirmation result as a confirmation result for the target project.

The estimation unit 120 estimates an implementation item to be implemented for a target project. For example, the estimation unit 120 may estimate the implementation item using a parameter in the learning model. Specifically, the estimation unit 120 may estimate an implementation item relevant to an element whose weight exceeds a predetermined threshold in the learning model as an implementation item to be implemented. Using the example of Expression 1, the estimation unit 120 specifies an implementation item relevant to the weight exceeding a predetermined threshold among wᵢ that is a weight for each implementation item. Specifically, when the predetermined threshold is h, the estimation unit 120 extracts an implementation item relevant to a weight satisfying wᵢ>h. Then, the estimation unit 120 may regard the extracted implementation item as an implementation item to be implemented.

Alternatively, the estimation unit 120 may estimate an implementation item to be implemented in a case where the estimated confirmation result is a correction instruction. For example, it is assumed that the estimation unit 120 estimates that the confirmation result is the correction instruction for the target project using the learning model. The estimation unit 120 may estimate an implementation item relevant to an element having a weight exceeding a predetermined threshold among implementation items not implemented in the target project as an implementation item to be implemented. Using the example of Expression 1, the estimation unit 120 specifies an implementation item relevant to the weight exceeding a predetermined threshold among wᵢ that is a weight for each implementation item. Specifically, when the predetermined threshold is h, the estimation unit 120 extracts an implementation item relevant to a weight satisfying wᵢ>h. Then, the estimation unit 120 specifies an implementation item that is not implemented in the target project among the extracted implementation items. The estimation unit 120 may regard the specified implementation item as an implementation item to be implemented. The present disclosure is not limited to this example, and the estimation unit 120 may estimate the implementation item to be implemented based on the implementation state and the weight of the implementation item in the target project. This example will be described later.

An implementation item having a larger weight has a larger contribution degree to the estimation result. That is, it can be said that an implementation item having a large weight has a high importance level. Therefore, the estimation unit 120 can present an implementation item having a high importance level by estimating an implementation item relevant to an element whose weight exceeds a predetermined threshold as an implementation item to be implemented. In this case, the correction instruction indicates that the implementation item to be implemented is not appropriately implemented for the target project. That is, the estimated implementation item to be implemented is relevant to the basis of the correction instruction. That is, the estimation unit 120 may estimate an implementation item to be presented as a basis for a case where the confirmation result is a correction instruction.

The fact that the implementation item to be implemented is not appropriately implemented includes that the implementation state of the implementation item has not been implemented and that detailed information of the implementation item has not been appropriately input. With respect to the fact that the implementation state of the implementation item to be implemented has not been implemented, as described above, the estimation unit 120 may estimate, as the implementation item to be implemented, an implementation item relevant to an element having a weight exceeding a predetermined threshold among the implementation items that have not been implemented in the target project.

Regarding the fact that the detailed information of the implementation item is not appropriately input, the estimation unit 120 estimates the incomplete description of the detailed information of the implementation item. Specifically, the estimation unit 120 compares the detailed information of the implementation item in the target project with the sentence of the item description of the implementation item. A specific example of the comparison processing will be described later. In a case where there is a discrepancy between both sentences as a result of the comparison, the estimation unit 120 may estimate that there is an incomplete description. The present disclosure is not limited to this example, and the estimation unit 120 may compare the detailed information of the implementation item in the target project with the detailed information of the same implementation item in the project of which the confirmation result is regarded as approval among the projects executed in the past.

In this manner, the estimation unit 120 may estimate the incomplete description of the detailed information based on a comparison between at least one of the description of the implementation item included in the check list and the detailed information relevant to the implementation item in the input check list of the project determined to be appropriate in the past, and the detailed information of the target project.

The output unit 130 outputs the estimated information. Specifically, the output unit 130 may output the confirmation result estimated for the target project, the implementation item to be implemented, and the incomplete description of the detailed information. At this time, the output unit 130 may output the estimated information to the terminal device 200. As a result, the estimated information may be displayed on the output device 220 of the terminal device 200.

Next, a specific example of the estimation processing using the learning model will be described. In the present specific example, it is assumed that a learning model learned for the function f expressed by Expression 1 is generated.

The acquisition unit 110 acquires the characteristic information of the target project and the target check list. The estimation unit 120 quantifies the acquired characteristic information and target check list. The quantification method may be similar to the processing by the learning data generation unit 141 in the learning phase.

First, the estimation unit 120 sets the levels of confidentiality, integrity, and availability indicated in the characteristic information as t₁′, t₂′, and t₃′. Then, the estimation unit 120 calculates T₁′, T₂′, and T₃′ that are values obtained by normalizing t₁′, t₂′, and t₃′.

The estimation unit 120 quantifies the implementation status of each implementation item based on the target check list. First, the estimation unit 120 sets the implementation state of the implementation item to xᵢ′. The estimation unit 120 sets the detailed information of the implementation item as yᵢ′.

Then, the estimation unit 120 estimates the confirmation result z′ using the function f that is a learning model. Specifically, the following Expression 2 is used.

z′=f(w₁x₁′y₁′,w₂x₂′y₂′, . . . ,wₙxₙ′yₙ′,T₁′,T₂′,T₃′) [Math. 2]

The estimation unit 120 estimates whether the confirmation result is approval or a correction instruction based on the numerical value output by the learning model.

Here, in a case where the confirmation result is a correction instruction, the estimation unit 120 may estimate the incomplete description of the implementation item to be implemented and the detailed information as a basis of the correction instruction. For example, the estimation unit 120 specifies an implementation item that has not been implemented in the target project among the implementation items. Then, the estimation unit 120 specifies an implementation item of which the weight wᵢ attached to the element of the learning model relevant to the specified implementation item is equal to or more than a predetermined threshold. The estimation unit 120 may estimate the specified implementation item as an implementation item to be implemented for a target project.

Alternatively, the estimation unit 120 may estimate the implementation item to be implemented based on the implementation state and the weight of the implementation item in the target project. Specifically, the estimation unit 120 calculates the contribution degree for each implementation item. The contribution degree indicates the degree to which the implementation state of the implementation item has contributed to the estimation result of the correction instruction. The contribution degree is cᵢ. For example, cᵢ may be expressed as the following Expression 3.

cᵢ=wᵢ(1−xᵢ′) [Math. 3]

In this manner, the estimation unit 120 may calculate the contribution degree by the product of the weight and the implementation state. Here, in a case where the implementation state is “implemented”, xᵢ′=1.0. When the implementation state is “partially implemented”, xᵢ′=0.6 is set. When the implementation state is “to be implemented”, xᵢ′=0.3 is set. When the implementation state is “not implemented”, xᵢ′=0.0 is set. The weight wᵢ takes a value from 0 to 1. In this case, the larger the weight, the larger the contribution degree. The closer to the non-implementation, the larger the contribution degree. In this example, the contribution degree of the implemented item is 0. For example, the estimation unit 120 calculates the contribution degree for each implementation item. Then, the estimation unit 120 specifies an implementation item having a contribution degree equal to or greater than a predetermined threshold among the calculated contribution degrees. The estimation unit 120 may estimate the specified implementation item as an implementation item to be implemented for the target project.

The estimation unit 120 estimates the incomplete description of details. Specifically, the estimation unit 120 compares the detailed information for each implementation item of the target check list with the item description for each implementation item. Here, the item description of the implementation item is aᵢ. aᵢ may be information obtained by converting the sentence indicated in the item description into vector representation by an algorithm such as Doc2 Vec. The estimation unit 120 compares detailed information yᵢ′ and aᵢ for each implementation item of the target check list. As a result of the comparison, in a case where the distance between yᵢ′ and aᵢ is equal to or more than the predetermined threshold, the estimation unit 120 determines that yᵢ′ and aᵢ are separated from each other. Then, the estimation unit 120 estimates that there is an incomplete description in the detailed information yᵢ′ determined to be deviated.

Alternatively, the estimation unit 120 compares the detailed information for each implementation item of the target check list with the detailed information for each implementation item of the input check list in the project executed in the past. At this time, the detailed information for each implementation item of the input check list in the project whose confirmation result is determined to be approved among the projects executed in the past is to be compared. It is assumed that yᵢ is detailed information to be compared for each implementation item of the input check list. The estimation unit 120 compares yᵢ′ and yᵢ. As a result of the comparison, in a case where the distance between yᵢ′ and yᵢ is equal to or more than the predetermined threshold, the estimation unit 120 determines that yᵢ′ and yᵢ deviate from each other. Then, the estimation unit 120 estimates that there is an incomplete description in the detailed information yᵢ′ determined to be deviated.

For example, it is assumed that “confirm that the user authentication function is correctly implemented” is described in the item description relevant to al. It is assumed that “code review has been performed to confirm that two-factor authentication has been working properly and session management has been securely performed when the user has logged in” is described in the detailed information relevant to y₁. It is assumed that “code review has been done but two-factor authentication has not worked correctly for some users and vulnerability has been found in session management” is described in the detailed information relevant to y₁′. In this case, when y₁′ and a₁ are compared with each other, it is reported that correct implementation is required in the implementation item, but there is incompleteness in y₁′, and thus there is incompleteness in the description. In such a case, the estimation unit 120 estimates that there is an incomplete description in the detailed information of the implementation item. When y₁′ and y₁ are compared, specific implementing contents in y₁ and proper operation of the contents are reported, whereas implementation in y₁′ is reported. In such a case, the estimation unit 120 estimates that there is an incomplete description in the detailed information of the implementation item.

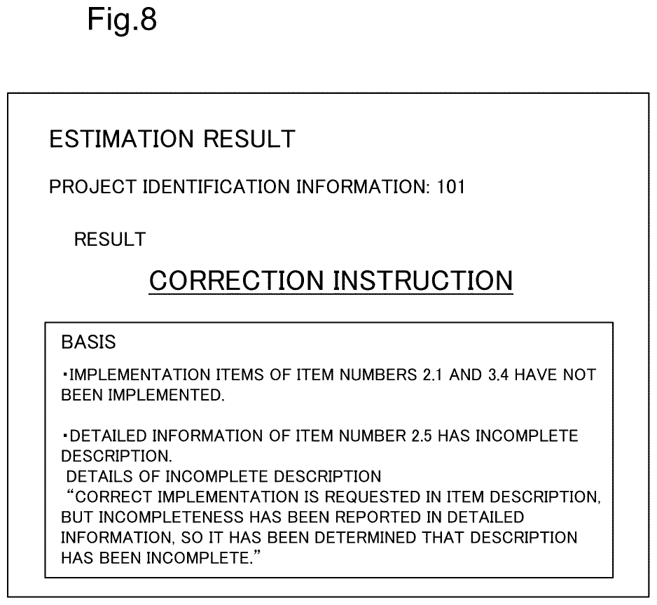

The output unit 130 outputs the estimated information. The information output by the output unit 130 is referred to as output information. FIG. 8 is a diagram illustrating an example of the output information. More specifically, FIG. 8 is a diagram illustrating a display screen showing various estimation results for a target project. In this example, a confirmation result of “correction instruction” is estimated for a project whose project identification information is “101”, which is a target project. The basis is presented together with the confirmation result of “correction instruction”. In this example, the fact that the implementation state of the implementation item to be implemented has not been completed and the fact that the detailed information of the implementation item has not been appropriately input are presented as bases. Specifically, a sentence “the implementation items of item numbers 2.1 and 3.4 have not been implemented” and a sentence “the detailed information of item number 2.5 has an incomplete description” are shown. Further, a sentence “the correct implementation is requested in the item description, but incompleteness has been reported in the detailed information, so it has been determined that the description has been incomplete” is shown as details of the incomplete description. In this manner, since the information processing device 100 can present the confirmation result and the basis thereof, it is possible to prompt the user to perform efficient correction work. The sentence as illustrated in the example of FIG. 8 may be generated by natural language generation (NLG) or the like for the implementation item specified by the estimation unit 120.

### Operation Example of Information Processing Device 100

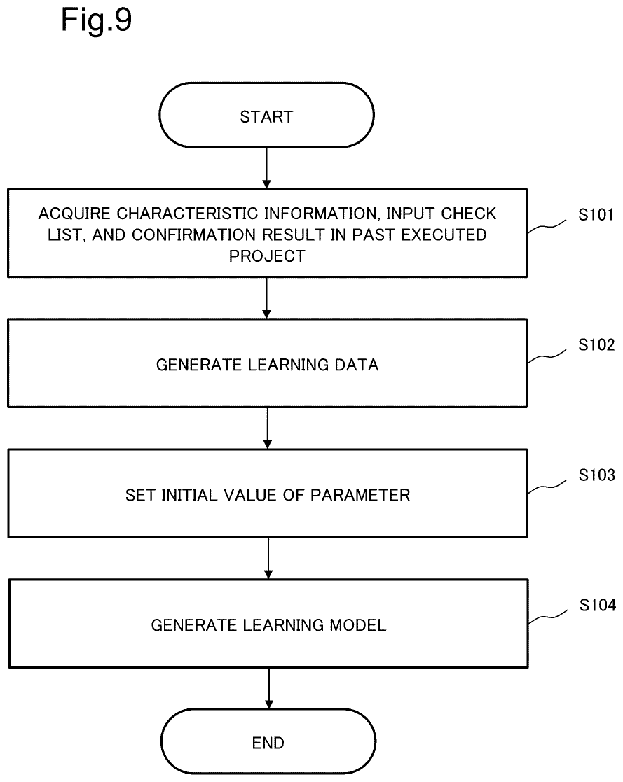

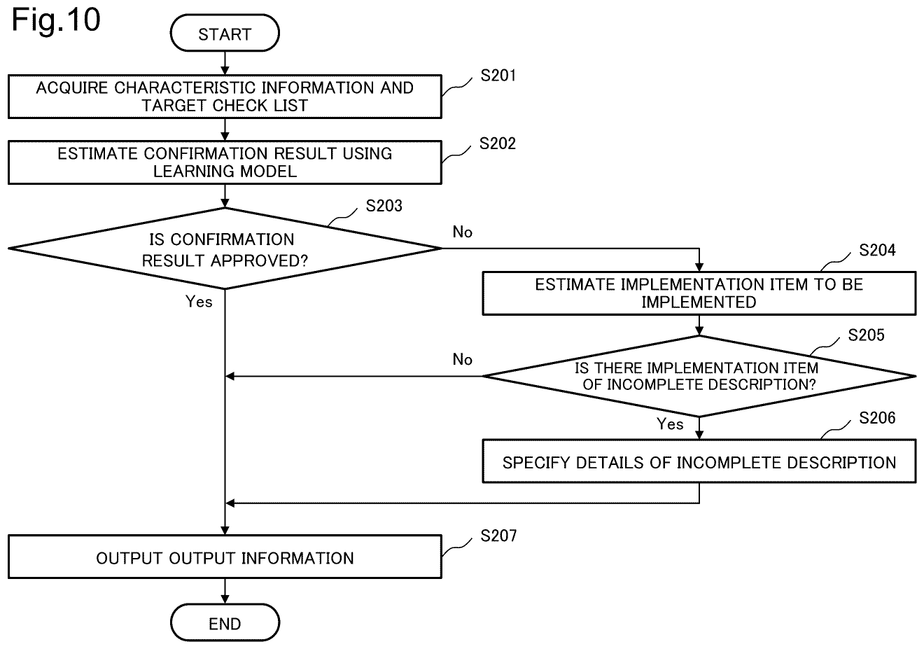

Next, an exemplary operation of the information processing device 100 will be described with reference to FIGS. 9 and 10. FIG. 9 is a second flowchart for explaining an example of the operation of the information processing device 100. More specifically, FIG. 9 is a flowchart for explaining an example of the operation of the information processing device 100 in the learning phase.

First, the learning data generation unit 141 acquires the characteristic information, the input check list, and the confirmation result in the project executed in the past (S101). For example, the learning data generation unit 141 acquires each piece of information from the storage device 190. Then, the learning data generation unit 141 generates learning data (S102). For example, the learning data generation unit 141 digitizes the acquired information and associates the characteristic information, the input check list, and the confirmation result for each project. At this time, the confirmation result is associated as a ground truth label.

The parameter setting unit 142 sets an initial value of the parameter (S103). Specifically, the parameter setting unit 142 sets an initial value of the weight for each implementation item.

The model generation unit 143 generates a learning model (S104). Specifically, the model generation unit 143 performs learning processing using the generated learning data and the initial value of the weight. The function constructed by the learning processing may be used as the learning model.

Next, an operation example of the information processing device 100 in the inference phase will be described. FIG. 10 is a third flowchart for explaining an example of the operation of the information processing device 100. More specifically, FIG. 10 is a flowchart for explaining an example of the operation of the information processing device 100 in the inference phase.

The acquisition unit 110 acquires the characteristic information and the target check list in the target project (S201). The estimation unit 120 estimates the confirmation result for the target project using the learning model (S202). Specifically, the estimation unit 120 obtains an output of the confirmation result by inputting the characteristic information and the target check list in the target project to the learning model.

When the confirmation result is approval, it indicates that the security countermeasure is appropriately implemented for the target project. Therefore, in a case where the confirmation result is approval (“Yes” in S203), the information processing device 100 performs the processing of S207.

When the confirmation result is the correction instruction, it is considered that the security countermeasure is not appropriately implemented for the target project. Therefore, when the confirmation result is the correction instruction (“No” in S203), the estimation unit 120 estimates the implementation item to be implemented for the target project (S204). Specifically, the estimation unit 120 may estimate an implementation item having a high importance level among implementation items that have not been implemented. For example, the estimation unit 120 estimates an implementation item relevant to an element having a weight exceeding a predetermined threshold among implementation items not implemented in the target project as an implementation item to be implemented. Alternatively, the estimation unit 120 may estimate an implementation item for which detailed information is not appropriately input. For example, the estimation unit 120 estimates the incomplete description of the detailed information based on a comparison between at least one of the description of the implementation item included in the check list and the detailed information relevant to the implementation item in the input check list of the project determined to be appropriate in the past, and the detailed information of the target project. Then, the estimation unit 120 may specify an implementation item with incomplete description.

In a case where there is no incomplete description of the implementation item (“No” in S205), the information processing device 100 proceeds to the processing of S207. In a case where there is an implementation item of the incomplete description (“Yes” in S205), the estimation unit 120 specifies details of the incomplete description (S206). Specifically, the estimation unit 120 generates a document indicating the basis of the incomplete description by natural language generation based on the result of the comparison processing performed at the time of estimating the implementation item for which the detailed information has not been appropriately input.

Then, the output unit 130 outputs the output information (S207). Specifically, the output unit 130 may output output information including information estimated in the processing of S202 to S206. At this time, for example, the output information may be displayed on the output device 220 of the terminal device 200.

This operation example is merely an example. That is, the operation example of the information processing device 100 is not limited to the above example.

In this manner, the information processing device 100 according to the second example embodiment acquires the characteristic information indicating the characteristic regarding the security of the project in the target project and the target check list that is the check list regarding the implementation item of the security countermeasure input for the target project. The information processing device 100 estimates the implementation item to be implemented for the target project using the learning model that has learned the relationship between the characteristic information and the input check list for each project and the confirmation result regarding the implementation status of the implementation item and the acquired characteristic information and target check list. Then, the information processing device 100 outputs the estimated implementation item to be implemented.

As a result, the information processing device 100 can present the implementation item to be implemented for the target project. Therefore, the user such as a person in charge of the project and a project manager can easily confirm, for example, which security countermeasure is to be implemented and whether the security countermeasure to be implemented is appropriately implemented. That is, the information processing device 100 can support confirmation work regarding security countermeasures to be implemented in a project.

The implementation status of the implementation item is input to the check list, and the implementation status includes an implementation state for each implementation item and detailed information that is a sentence indicating details of the implementation state. The confirmation result includes information indicating the appropriateness of the security countermeasure for the project, which is determined based on the input check list. At this time, the information processing device 100 may estimate the confirmation result for the target project based on the learning model and the acquired characteristic information and target check list. The information processing device 100 may output the estimated confirmation result.

As a result, the information processing device 100 can present information indicating the appropriateness of the security countermeasure for the target project. Therefore, the user such as a person in charge of the project and a project manager can confirm whether the security countermeasure is appropriately implemented for the target project.

The learning model may be configured based on an element relevant to the implementation item. A weight relevant to the implementation item based on the acquired characteristic information may be set to each element. Then, the information processing device 100 may estimate the implementation item to be implemented for the target project based on the implementation state for each implementation item in the target project and the weight set in the learning model. As a result, the information processing device 100 can present an implementation item that has a large weight and is not implemented for the target project as an implementation item to be implemented, for example.

The information processing device 100 may estimate the incomplete description of the detailed information based on a comparison between at least one of the description of the implementation item included in the check list and the detailed information relevant to the implementation item in the input check list of the project determined to be appropriate in the past, and the detailed information of the target project. Then, the information processing device 100 may output the estimated incomplete description. As a result, in a case where a sentence indicating details of the implementation state is input to the check list, the information processing device 100 can present the incomplete description of the input.

The characteristic information may indicate a level of confidentiality, availability, and integrity required for the project. The project information used in the estimation processing is only the characteristic information. That is, the information processing device 100 can perform the estimation processing without using detailed information regarding the project.

### First Modified Example

In the above example, the example of generating the learning model also using the characteristic information as an input has been described. The generation of the learning model is not limited to the above example. For example, the learning model may be generated for each pattern of the level of the characteristic information. The pattern of the level of the characteristic information is, for example, a combination of levels of confidentiality, integrity, and availability.

As an example, the model generation unit 143 sets the learning model for each pattern of the level of the characteristic information. The characteristic information indicates the levels of confidentiality, integrity, and availability. That is, the model generation unit 143 may generate the learning model for each possible pattern of the levels of confidentiality, integrity, and availability. For example, it is assumed that the levels of confidentiality, integrity, and availability are indicated in five stages. At this time, the model generation unit 143 may generate 5×5×5=125 learning models.

In the learning phase, the learning data generation unit 141 acquires project information, an input check list, and a confirmation result for each project executed in the past. Then, the learning data generation unit 141 generates learning data based on the project information, the input check list, and the confirmation result. At this time, the learning data generation unit 141 may generate the learning data for each pattern of the level of the characteristic information. For example, the learning data generation unit 141 organizes the information acquired for each level pattern of the characteristic information. Specifically, in a case where the levels of confidentiality, integrity, and availability are each 1, the learning data generation unit 141 generates data in which the input check list and the confirmation result of the project for which the levels of confidentiality, integrity, and availability are each 1 are associated with each other. In this manner, the learning data generation unit 141 may generate data in which the input check list and the confirmation result are associated with each pattern of the level of the characteristic information. At this time, the parameter setting unit 142 sets a weight for each pattern of the level of the characteristic information.

The model generation unit 143 performs learning processing for each pattern of the level of the characteristic information using the learning data and the initial value of the weight. At this time, for example, a function such as the following Expression 4 is defined.

z=f(w₁x₁y₁,w₂x₂y₂, . . . ,wₙxₙyₙ) [Math. 4]

The function f expressed in Expression 4 exists for each pattern of the level of the characteristic information. For example, the model generation unit 143 performs learning with the learning data and the initial value of the weight as inputs for each pattern of the level of the characteristic information for the function f shown in Expression 4. As a result, the learning model is generated for each pattern of the level of the characteristic information. That is, each of the generated learning models is associated with the pattern of the level of the characteristic information.

In the inference phase, the estimation unit 120 specifies a learning model relevant to the characteristic information of the target project. At this time, the estimation unit 120 may specify the learning model associated with the pattern of the level of the characteristic information that matches the pattern of the level of the characteristic information of the target project. Alternatively, the estimation unit 120 may specify the learning model associated with the pattern of the level of the characteristic information similar to the pattern of the level of the characteristic information of the target project. Alternatively, the estimation unit 120 may specify a learning model associated with a pattern of a level of characteristic information in which a difference in level from each of confidentiality, integrity, and availability of the target project is smaller than a predetermined value. Alternatively, the estimation unit 120 may specify a learning model in which a pattern of a level of the characteristic information of the target project and a pattern of a level of the characteristic information having a distance smaller than a predetermined value are associated with each other. In this case, the distance is, for example, any of a Euclidean distance, a Mahalanobis distance, a Chebyshev distance, or a Manhattan distance, but is not limited to this example.

Then, the estimation unit 120 inputs the acquired characteristic information and the information of the target check list to the identified learning model.

### Second Modified Example

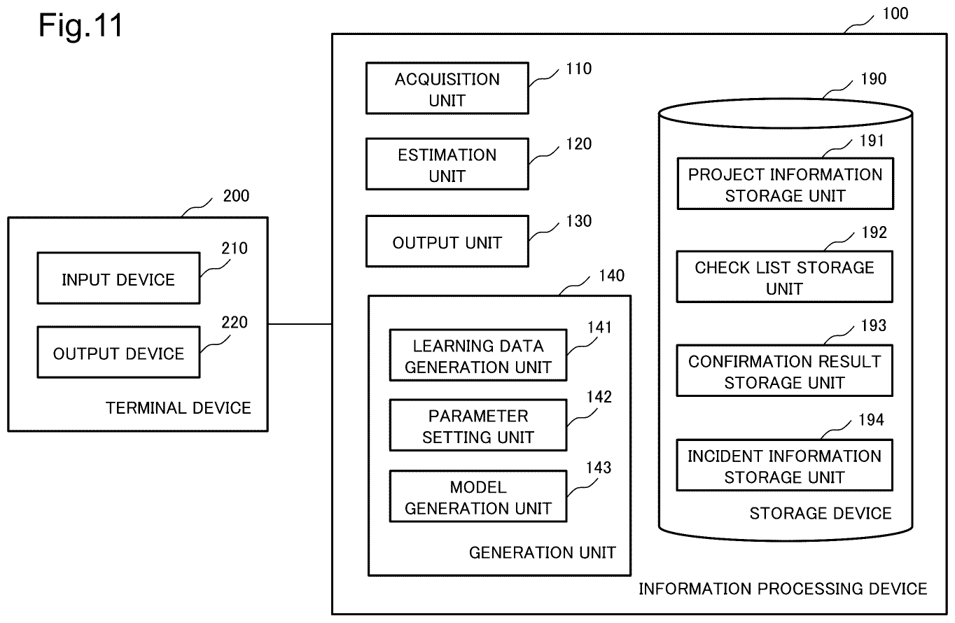

The information processing device 100 can perform processing using further information. FIG. 11 is a second block diagram illustrating an example of a functional configuration of the information processing device 100. The information processing device 100 illustrated in FIG. 11 is different from the information processing device 100 in FIG. 4 in that the storage device 190 further includes an incident information storage unit 194.

The incident information storage unit 194 stores incident information. The incident information is information indicating an incident that has occurred for a project. An incident is an inappropriate event with the potential to develop into a serious incident or accident. Examples of the incident in system development and operation include personal information that should not be described in an error message, and a state in which confidential information can be presented to an unauthorized user. In the present disclosure, the incident may be an event related to security. The incident is not limited to this example.

When an incident occurs in a project, information indicating the incident that has occurred associated with the project is stored in the incident information storage unit 194 as incident information by a user operation or the like.

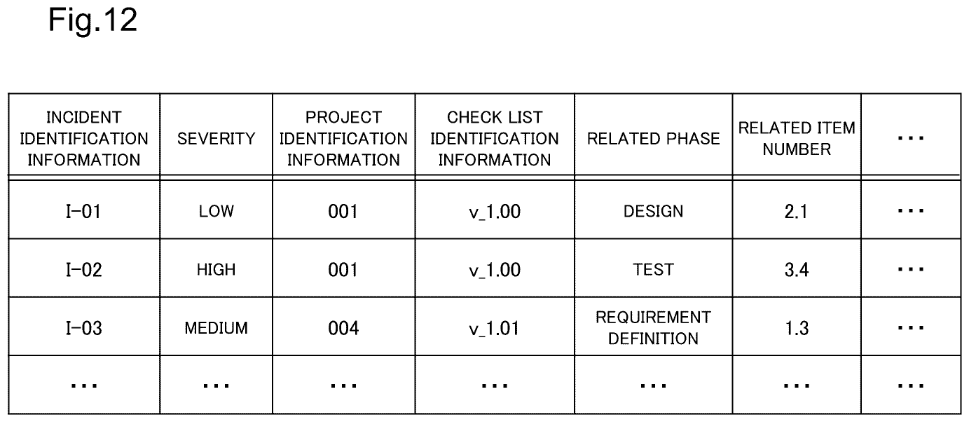

FIG. 12 is a diagram illustrating an example of incident information. In the example of FIG. 12, information in which the incident identification information, the severity, the project identification information, the check list identification information, the related phase, and the related item number are associated is illustrated. The incident identification information is information for identifying the incident that has occurred. The severity is an index indicating the magnitude of the influence of the incident. In this example, the severity is indicated by “high”, “medium”, and “low”. The related phase is information indicating which phase of the project the incident that has occurred is related to. The related item number is information indicating the item number of the implementation item in the check list related to the incident that has occurred. For example, in the record of the first line, it can be seen that the incident of which the incident identification information is “I-01” has occurred in the project of the project identification information “001”. It is indicated that the incident relates to the implementation item of the item number “2.1” in the check list of the check list identification information “v_1.00”.

The information processing device 100 can perform further processing using such incident information. For example, in the learning phase, the acquisition unit 110 acquires the incident information. The learning data generation unit 141 generates learning data with the confirmation result as a ground truth label. At this time, the learning data generation unit 141 may correct the ground truth label using the incident information. Specifically, it is assumed that the confirmation result is determined to be “approved” in a predetermined project that is one project executed in the past. In this case, the learning data relevant to the predetermined project indicates that the confirmation result is “approved” as the ground truth label. On the other hand, it is assumed that an incident has occurred in the predetermined project. In this case, it is possible to regard the predetermined project as the confirmation result determined to be “approved” even though the security countermeasure has not been appropriately implemented. Therefore, the learning data generation unit 141 corrects the ground truth label relevant to the predetermined project and generates the learning data. In this example, the learning data generation unit 141 sets “correction instruction” as the ground truth label.

In this manner, in a case where the confirmation result relevant to the predetermined project indicates that the security countermeasure is appropriate and an incident has occurred in the predetermined project, the learning data generation unit 141 may correct the ground truth label relevant to the predetermined project so as to indicate that the security countermeasure is not appropriate.

As a result, the information processing device 100 can suppress generation of learning data to which an incorrect ground truth label is attached.

In the learning phase, the parameter setting unit 142 may set the initial value of the weight using the incident information. Specifically, the parameter setting unit 142 specifies the implementation item related to the incident that has occurred by using the incident information. Then, the parameter setting unit 142 may set an initial value of the weight of the specified implementation item according to the severity of the incident.

For example, in the incident information of FIG. 11, an incident of which the incident identification information is “I-01” has a severity of “low” and a related item number of “2.1”. The incident of which the incident identification information is “I-02” has a severity of “high” and a related item number of “3.4”. In this case, the parameter setting unit 142 may set the initial values of the weights relevant to the implementation item with the item number “2.1” and the implementation item with the item number “3.4” to be larger than the initial values of the weights relevant to the other implementation items. At this time, the parameter setting unit 142 may set the initial value of the weight relevant to the implementation item whose item number is “3.4” to be larger than the initial value of the weight relevant to the implementation item whose item number is “2.1”. Alternatively, the parameter setting unit 142 may set the initial value of the weight relevant to the implementation item of the item number “3.4” related to the incident of which the severity is “high” to be larger than the initial values of the weights relevant to the other implementation items.

In this manner, the parameter setting unit 142 may change the initial value of the weight of the implementation item related to the incident that has occurred based on the incident information.

As a result, since the initial value is appropriately set, an increase in time required for learning can be suppressed.

### Third Modified Example

Various machine learning methods may be used to generate the learning model. For example, the machine learning method may be ensemble learning such as gradient boosting or deep learning such as BERT.

For example, in a case where ensemble learning such as gradient boosting is used, the characteristic information of the project and the implementation status of the implementation item of the check list are set as features, and the confirmation result is set as a label. In the gradient boosting, a feature importance level can be calculated in a model construction process or after construction. The feature importance level indicates the degree of influence of the feature on the output of the model. That is, the feature importance level is relevant to a weight for each implementation item in the present application. For example, in the inference phase, the estimation unit 120 may estimate an implementation item relevant to a feature whose feature importance level exceeds a predetermined threshold as an implementation item to be implemented. Alternatively, the estimation unit 120 may estimate an implementation item relevant to an element having a feature importance level exceeding a predetermined threshold among implementation items not implemented in the target project as an implementation item to be implemented.

For example, in a case where deep learning such as BERT is used, the input layer receives the characteristic information of the project and the implementation status of the implementation item of the check list, and the output layer outputs the confirmation result. At this time, for example, the contribution degree of each input to the output can be calculated by a method such as a layer-by-layer relevance propagation method. That is, the contribution degree is relevant to a weight for each implementation item in the present application. For example, in the inference phase, the estimation unit 120 may estimate an implementation item relevant to an input whose contribution degree exceeds a predetermined threshold as an implementation item to be implemented. Alternatively, the estimation unit 120 may estimate an implementation item relevant to an element having a contribution degree exceeding a predetermined threshold among implementation items not implemented in the target project as an implementation item to be implemented.

### Hardware Configuration Example of Information Processing Device

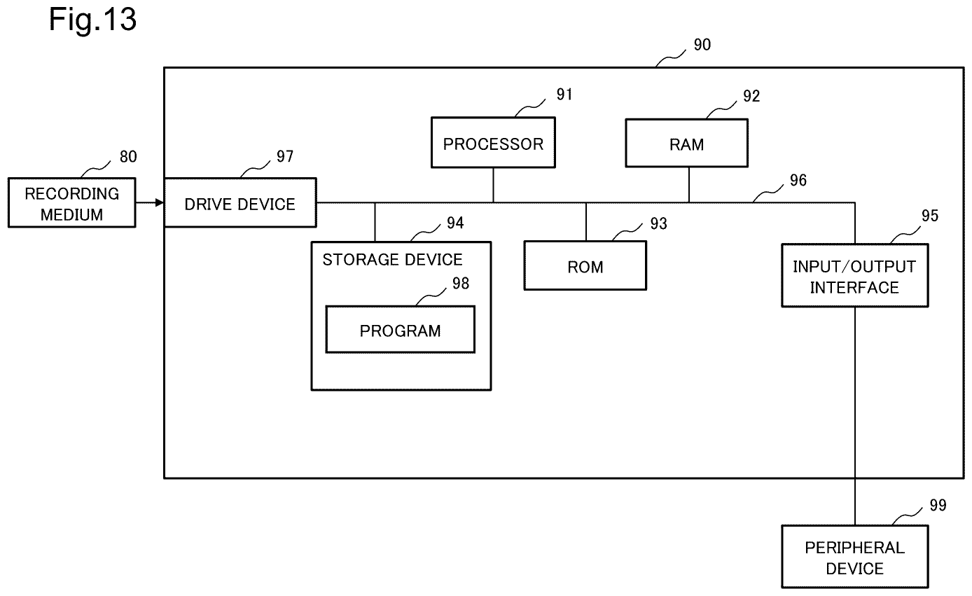

Hardware constituting the information processing devices of the first and second example embodiments will be described. FIG. 13 is a block diagram illustrating an example of a hardware configuration of a computer device constituting the information processing device according to each example embodiment. In a computer device 90, the information processing device and the information processing method described in each example embodiment and each modification example are implemented. For example, the information processing device and the like described in each example embodiment and each modification example may have the hardware configuration illustrated in FIG. 13.

As illustrated in FIG. 13, the computer device 90 includes a processor 91, a random access memory (RAM) 92, a read only memory (ROM) 93, a storage device 94, an input/output interface 95, a bus 96, and a drive device 97. The information processing device and the like may be implemented by multiple electric circuits.

The storage device 94 stores a program (computer program) 98. The processor 91 executes the program 98 of the present information processing device using the RAM 92. Specifically, for example, the program 98 includes a program that causes a computer to execute the processing illustrated in FIGS. 2, 9, and 10. When the processor 91 executes the program 98, the function of each configuration of the present information processing device is implemented. The program 98 may be stored in the ROM 93. The program 98 may be recorded in a recording medium 80 and read by the drive device 97, or may be transmitted from an external device (not illustrated) to the computer device 90 via a network (not illustrated).

The input/output interface 95 exchanges data with a peripheral device (such as a keyboard, a mouse, or a display device) 99. The input/output interface 95 functions as a means for acquiring or outputting data. The bus 96 connects the components with each other.

There are various modifications of the method for implementing the information processing device. For example, each of the components included in the information processing device can be implemented as a dedicated device. The information processing device can be implemented based on a combination of multiple devices.

A processing method for causing a recording medium to record a program for implementing each component in the function of each example embodiment, reading the program recorded in the recording medium as a code, and causing a computer to execute the program is also included in the scope of each example embodiment. That is, a non-transitory computer-readable recording medium is also included in the scope of each example embodiment. The recording medium recording the above-described program and the program itself are also included in each example embodiment.

The recording medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. The program recorded in the recording medium is not limited to a program for executing processing by itself, and programs that run on an operating system (OS) to execute processing in cooperation with other software and functions of an extension board are also included in the scope of each example embodiment.

While the invention of the present application has been described with reference to the example embodiments, the invention of the present application is not limited to these example embodiments. It will be understood by those of ordinary skill in the art that various changes in form and details may be made therein without departing from the spirit and scope of the invention of the present application as defined by the claims.

It is necessary to implement security countermeasures in projects such as system development and operation. For example, a person in charge of a project may implement a security countermeasure by using a check list in which implementation items regarding the security countermeasure are described. For example, a security manager in a project or the like may check whether security countermeasures have been appropriately implemented using the check list.

That is, in a project, it may be required to confirm which security countermeasure should be implemented or whether the security countermeasure to be implemented is appropriately implemented. However, in a case where there are a large number of implementation items, a determination criterion as to whether appropriate implementation is unclear, or the like, such confirmation work may take time and effort.

JP 2013-61694 A does not disclose a technique related to checking of security countermeasures in such a situation.

One example of an object of the present disclosure has been made in view of the above problems, and is to provide an information processing device and the like capable of supporting confirmation work regarding security countermeasures to be implemented in a project.

According to the present disclosure, it is possible to support confirmation work regarding security countermeasures to be implemented in a project.

The above-described example embodiments and modification examples can be appropriately combined with each other.

### <Supplementary Note>

Some or all of the above-described example embodiments may be described as the following supplementary notes, but are not limited to the following.

### [Supplementary Note 1]

An information processing device including:
an acquisition means for acquiring characteristic information indicating a characteristic regarding security of a project in a target project, and a target check list that is a check list regarding an implementation item of a security countermeasure input for the target project;
an estimation means for estimating the implementation item to be implemented for the target project using a learning model that has learned a relationship between the characteristic information and the check list input for each project and a confirmation result regarding an implementation status of the implementation item and the acquired characteristic information and the acquired target check list; and an output means for outputting the estimated implementation item to be implemented.

### [Supplementary Note 2]

The information processing device according to Supplementary Note 1, in which
the implementation status of the implementation item is input to the check list,
the implementation status includes an implementation state for each of the implementation items and detailed information that is a sentence indicating details of the implementation state,
the confirmation result includes information indicating appropriateness of the security countermeasure for the project, the information being determined based on the input check list,
the estimation means estimates the confirmation result for the target project based on the learning model, and the acquired characteristic information and the acquired target check list, and
the output means outputs the estimated confirmation result.

### [Supplementary Note 3]

The information processing device according to Supplementary Note 2, in which
the learning model is configured based on an element relevant to the implementation item,
a weight relevant to the implementation item based on the acquired characteristic information is set to each of the elements, and
the estimation means estimates the implementation item to be implemented for the target project based on the implementation state for each of the implementation items in the target project and the weight set in the learning model.

### [Supplementary Note 4]

The information processing device according to Supplementary Note 2, in which
the estimation means estimates an incomplete description of detailed information based on a comparison between at least one of a description of the implementation item included in the check list and detailed information relevant to the implementation item in the input check list of the project determined to be appropriate in a past and detailed information of the target project, and
the output means outputs the estimated incomplete description.

### [Supplementary Note 5]

The information processing device according to Supplementary Note 1, including
a generation means for generating learning data with the confirmation result as a ground truth label based on the characteristic information, the check list having been input, and the confirmation result in a past project, setting an initial value of a weight for each implementation item, and generating the learning model using the learning data and the weight.

### [Supplementary Note 6]

The information processing device according to Supplementary Note 5, in which
the acquisition means acquires incident information indicating an incident that has occurred in a project, and
in a case where the confirmation result relevant to a predetermined project indicates that a security countermeasure is appropriate and an incident has occurred in the predetermined project, the generation means corrects a ground truth label relevant to the predetermined project in such a way as to indicate that the security countermeasure is not appropriate.

### [Supplementary Note 7]

The information processing device according to Supplementary Note 5, in which
the acquisition means acquires incident information indicating an incident that has occurred in a project, and
the generation means changes an initial value of the weight of the implementation item related to the incident that has occurred based on the incident information.

### [Supplementary Note 8]

The information processing device according to any one of Supplementary Notes 1 to 7, in which
the characteristic information indicates levels of confidentiality, availability, and integrity required for a project.

### [Supplementary Note 9]

An information processing method including:
acquiring characteristic information indicating a characteristic regarding security of a project in a target project, and a target check list that is a check list regarding an implementation item of a security countermeasure input for the target project;
estimating the implementation item to be implemented for the target project using a learning model that has learned a relationship between the characteristic information and the check list input for each project and a confirmation result regarding an implementation status of the implementation item and the acquired characteristic information and the acquired target check list; and
outputting the estimated implementation item to be implemented.

### [Supplementary Note 10]

A non-transitory computer-readable recording medium storing a program for causing a computer to execute a process comprising:
acquiring characteristic information indicating a characteristic regarding security of a project in a target project, and a target check list that is a check list regarding an implementation item of a security countermeasure input for the target project;
estimating the implementation item to be implemented for the target project using a learning model that has learned a relationship between the characteristic information and the check list input for each project and a confirmation result regarding an implementation status of the implementation item and the acquired characteristic information and the acquired target check list; and
outputting the estimated implementation item to be implemented.

Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Some or all of the configurations described as a Supplementary Note can be similarly dependent on various hardware, software, various recording means for recording software, or systems without departing from the above-described example embodiments.

1. An information processing device comprising:
at least one memory configured to store instructions; and
at least one processor configured to execute the instructions to:
acquire characteristic information indicating a characteristic regarding security of a project in a target project, and a target check list that is a check list regarding an implementation item of a security countermeasure input for the target project;
estimate the implementation item to be implemented for the target project using a learning model that has learned a relationship between the characteristic information and the check list input for each project and a confirmation result regarding an implementation status of the implementation item and the acquired characteristic information and the acquired target check list; and
output the estimated implementation item to be implemented.

2. The information processing device according to claim 1, wherein
the implementation status of the implementation item is input to the check list,
the implementation status includes an implementation state for each of the implementation items and detailed information that is a sentence indicating details of the implementation state,
the confirmation result includes information indicating appropriateness of the security countermeasure for the project, the information being determined based on the input check list, and
the at least one processor further performs operation to:
estimate the confirmation result for the target project based on the learning model, and the acquired characteristic information and the acquired target check list, and
output the estimated confirmation result.

3. The information processing device according to claim 2, wherein
the learning model is configured based on an element relevant to the implementation item,
a weight relevant to the implementation item based on the acquired characteristic information is set to each of the elements, and
the at least one processor further performs operation to:
estimate the implementation item to be implemented for the target project based on the implementation state for each of the implementation items in the target project and the weight set in the learning model.

4. The information processing device according to claim 2, wherein the at least one processor further performs operation to:
estimate an incomplete description of detailed information based on a comparison between at least one of a description of the implementation item included in the check list and detailed information relevant to the implementation item in the input check list of the project determined to be appropriate in a past and detailed information of the target project, and
output the estimated incomplete description.

5. The information processing device according to claim 1, wherein the at least one processor further performs operation to:
generate learning data with the confirmation result as a ground truth label based on the characteristic information, the check list having been input, and the confirmation result in a past project, set an initial value of a weight for each implementation item, and generate the learning model using the learning data and the weight.

6. The information processing device according to claim 5, wherein the at least one processor further performs operation to:
acquire incident information indicating an incident that has occurred in a project, and
in a case where the confirmation result relevant to a predetermined project indicates that a security countermeasure is appropriate and an incident has occurred in the predetermined project, correct a ground truth label relevant to the predetermined project in such a way as to indicate that the security countermeasure is not appropriate.

7. The information processing device according to claim 5, wherein the at least one processor further performs operation to:
acquire incident information indicating an incident that has occurred in a project, and
change an initial value of the weight of the implementation item related to the incident that has occurred based on the incident information.

8. The information processing device according to claim 1, wherein
the characteristic information indicates levels of confidentiality, availability, and integrity required for a project.

9. An information processing method comprising:
acquiring characteristic information indicating a characteristic regarding security of a project in a target project, and a target check list that is a check list regarding an implementation item of a security countermeasure input for the target project;
estimating the implementation item to be implemented for the target project using a learning model that has learned a relationship between the characteristic information and the check list input for each project and a confirmation result regarding an implementation status of the implementation item and the acquired characteristic information and the acquired target check list; and
outputting the estimated implementation item to be implemented.

10. A non-transitory computer-readable recording medium storing a program for causing a computer to execute a process comprising:
acquiring characteristic information indicating a characteristic regarding security of a project in a target project, and a target check list that is a check list regarding an implementation item of a security countermeasure input for the target project;
estimating the implementation item to be implemented for the target project using a learning model that has learned a relationship between the characteristic information and the check list input for each project and a confirmation result regarding an implementation status of the implementation item and the acquired characteristic information and the acquired target check list; and
outputting the estimated implementation item to be implemented.
